(19) United States
(12) Patent Application Publication
(10) Pub. No.: US 2024/0288017 A1
(43) Pub. Date: Aug. 29, 2024

(54) DEVICE FOR FASTENING TO A COMPONENT

(71) Applicant: SPRINGFIX Befestigungstechnik GmbH, Salach (DE)

(72) Inventors: Sebastian Hippeli, Nordheim vor der Rhön (DE); Anja Eckle, Gingen an der Fils (DE)

(21) Appl. No.: 18/573,314

(22) PCT Filed: Jun. 9, 2022
(86) PCT No.: PCT/DE2022/200112

§ 371 Date: Dec. 21, 2023

(30) Foreign Application Priority Data
Jun. 28, 2021 (DE) 10 2021 206 692.5

(51) Int. Cl. F16B 5/02; F16B 43/00

(52) U.S. Cl. CPC F16B 5/025; F16B 43/00

(57) ABSTRACT

A device for fastening to a component having a base body and a compensating element, wherein the compensating element is connected to the base body via a thread, and wherein the compensating element has a passage with a driver device for a screw. At least one centering element for aligning the screw is formed in the passage.

### BACKGROUND

### Technical Field

The present disclosure relates to a device for fastening to a component having a base body and a compensating element, wherein the compensating element is connected to the base body via a thread, and wherein the compensating element has a passage with a driver device for a screw.

### Description of the Related Art

Devices of the type in question have been known in practice for years and serve, for example, for fixing two components whose distance from one another is subject to tolerances. Corresponding devices are used inter alia for mounting headlights in a motor vehicle.

In the known devices, a nut is arranged below the base body, into which nut a screw is screwed. When the screw is screwed into the thread of the nut, the compensating element is likewise rotated due to a driver device which connects the screw and the compensating element to one another. Because the direction of rotation of the screw connection of the base body and the compensating element is opposite from the thread of the nut, the compensating element is unscrewed from the base body when the screw is screwed in until it abuts against a second component with its stop region. This design therefore enables a tolerance compensation in the fixation of two components whose distance from one another is not absolutely certain, and is therefore also referred to as tolerance compensation element.

Corresponding devices are already known, for example, from FR 2 792 039 B1 and DE 100 34 968 A1.

In the automotive industry, for example, the assembly of such devices is in flow production which can therefore be completed in a relatively short time. It is also conceivable for the devices to be mounted automatically. It is problematic here that the driver devices are exposed to very high forces when the screws are being inserted, and damage can therefore occur. If the devices cannot be properly fastened due to damage, they must be replaced, which stops production, which must be avoided at all costs.

### BRIEF SUMMARY

The present disclosure is therefore based on the object of designing and developing a device of the type mentioned at the outset in such a way that reliable fastening is possible in a short time using structurally simple means, and damage to the device during assembly is avoided.

According to the present disclosure, a device is provided for fastening to a component having a base body and a compensating element, wherein the compensating element is connected to the base body via a thread, and wherein the compensating element has a passage with a driver device for a screw, characterized in that at least one centering element for aligning the screw is formed in the passage.

In accordance with the present disclosure, it has first been recognized that the screw should be inserted as centrally as possible into the passage for safe and quick assembly of the device. As a result, the screw does not tilt on the driver device, and it is therefore not damaged from the insertion movement. Also in accordance with the disclosure, it has been recognized that a centered insertion of the screw can be ensured in a particularly simple manner in that at least one centering element is formed in or on the passage. As a result, the screw is initially aligned during insertion in such a way that it can be guided past the driver device without tilting.

It should be noted that the screw does not necessarily have to be part of the disclosed device. However, it is possible for the screw to be part of this device.

The centering element can advantageously be designed as a centering rib or centering lug or centering projection reaching into the passage in the radial direction. The centering rib extends at least substantially parallel to the direction of insertion of the screw or to the extension direction of the passage. Such a design is particularly easy to manufacture and ensures that the screw is inserted correctly into the device.

In a further advantageous way, a plurality of centering elements, in particular centering ribs, a centering lug or centering projections, can be arranged in the circumferential direction of the passage. The screw can therefore be guided in the circumferential direction by a plurality of ribs, whereby the alignment can be adjusted very precisely. Preferably, the centering elements, for example the centering ribs, can each be designed equidistant from the nearest centering element, for example the nearest centering rib. For example, six centering ribs could each be arranged at an angle of 60° around the passage. Alternatively, it is conceivable to arrange a single centering element that runs in the circumferential direction, preferably completely, around the passage and extends in the radial direction into the passage.

In a particularly advantageous manner, the centering element can be formed integrally with the compensating element. Such a design is particularly simple to manufacture. For example, the compensating element and the centering element could consist of plastic and be manufactured in particular by injection molding.

In order to be able to insert the screw even more easily into the passage, the free end of the centering element can have a bevel. The bevel therefore serves as an insertion aid for the screw.

In a further advantageous manner, the driver device can be designed as a spring element. The spring element can be a spring clamp which is manufactured, for example, as a bent metal part. It is essential for the driver device to enter into a force-fit connection with the screw in order to rotate the compensating element during a rotation of the screw.

According to an advantageous embodiment, the driver device can be connected to the compensating element in a form fit. This ensures that the driver device is connected tightly enough to the compensating element in a particularly simple way, so that it can follow the rotational movement of the screw. “Slipping” between the compensating element and the driver device is prevented.

Advantageously, at least one fastening element can project into the passage in the radial direction in order to connect the driver device to the compensating element in a form fit. Such a fastening element is particularly easy to manufacture and can, for example, be formed in one piece with the compensating element.

In a particularly advantageous manner, the fastening element can be designed as a fastening rib or fastening lug or fastening projection which preferably projects into the passage in the radial direction. The fastening rib can run at least substantially parallel to the direction of insertion of the screw or to the extension direction of the passage.

According to another advantageous embodiment, the base body can have a base element and a retaining ring connected to the base element in a form fit. Such a multipart design has the advantage that the individual components are simpler to manufacture, for example a thread on the base element, which thread is designed to be complementary with a thread on the compensating element. It has also been recognized that a form fit between the base element and the retaining ring prevents these components from separating from each other even at higher torques, as is the case, for example, with devices known from the prior art, which are only fixed to each other by a force fit.

The retaining ring can advantageously have at least one groove or recess, and the base element can have at least one rib or a lug or a projection which is designed to be complementary with the groove in order to achieve a form fit. The groove and the rib could run at least substantially parallel to the direction of insertion of the screw or to the direction of extension of the passage.

It is furthermore conceivable and advantageous if at least two grooves have a different shape and/or that at least two ribs have a different shape. As a result, it can be easily achieved that the retaining ring and the base element can only be connected to one another in a certain position or in certain positions.

### BRIEF DESCRIPTION OF THE SEVERAL VIEWS OF THE DRAWINGS

There are various possibilities for designing and developing the teaching of the present disclosure in an advantageous manner. To this end, reference is made, on the one hand, to the claims referring back to claim 1 and, on the other, to the subsequent explanation of preferred exemplary embodiments of the disclosure based upon the drawing. Generally preferred embodiments and developments of the teaching are also explained in conjunction with the explanation of the preferred exemplary embodiments of the disclosure with reference to the drawing. In the drawings:

FIG. 1 shows a schematic representation of a sectional view of a device according to the present disclosure in its basic state,

FIG. 2 shows a schematic representation of a sectional view of the device according to FIG. 1 in the unscrewed state,

FIG. 3 shows a schematic representation of another view of the device according to FIG. 1,

FIG. 4 shows a schematic representation of a plan view of the device according to FIG. 1,

FIG. 5 shows a schematic representation of another plan view of the device according to FIG. 1,

FIG. 6 shows a schematic representation of a sectional view of the base body and the compensating element of the device according to FIG. 1,

FIG. 7 shows the representation from FIG. 6, wherein the driver device is also shown, and

FIG. 8 shows a schematic representation of a sectional view of the base body of the device according to FIG. 1.

### DETAILED DESCRIPTION

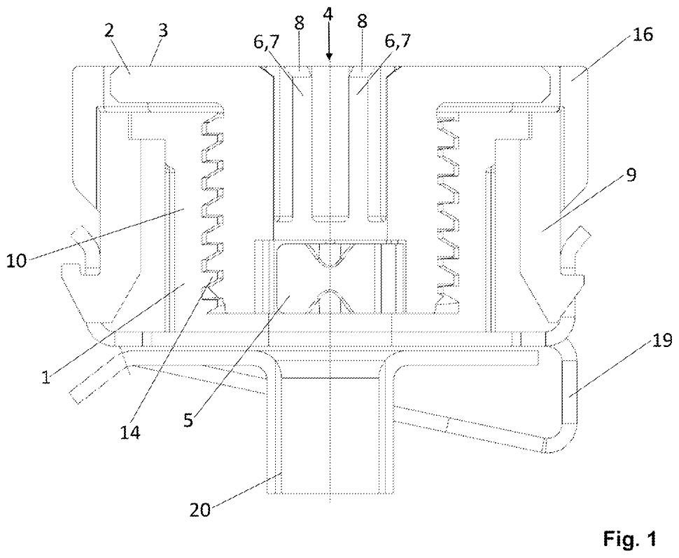

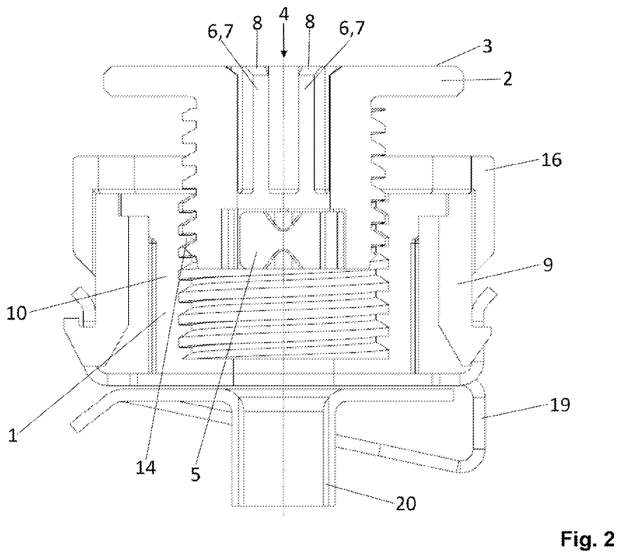

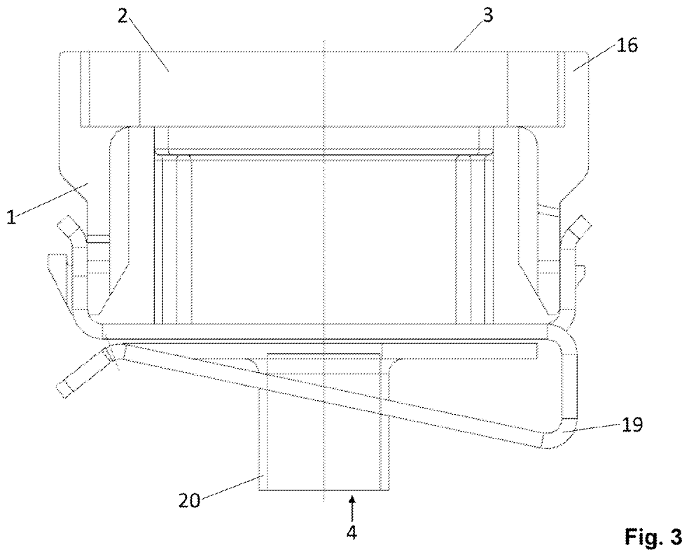

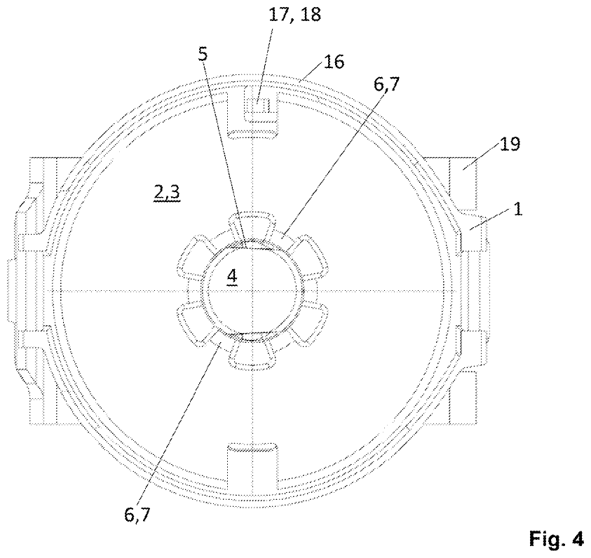

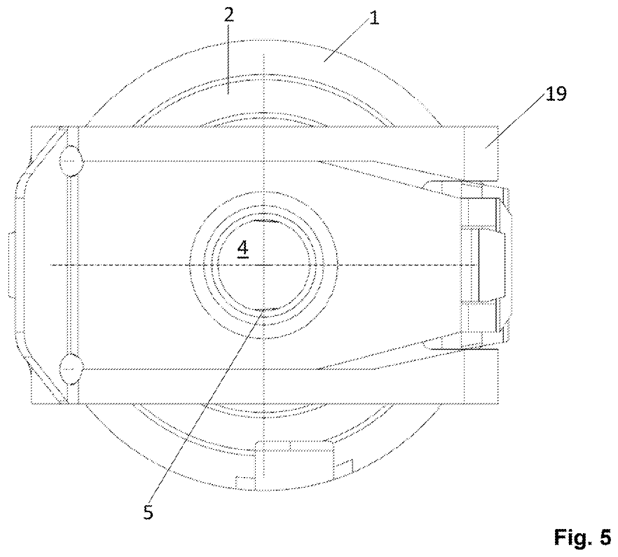

FIGS. 1 to 8 show an embodiment of a device according to the present disclosure, wherein, to improve clarity, not every component is provided with a reference sign in some figures.

The device serves for fastening to a component (not shown), in particular for tolerance compensation of two components to be connected to one another. The device comprises a base body 1 and a compensating element 2 which are connected to one another via a thread 14. The compensating element 2 has a stop surface 3 and a driver device 5 for a screw (not shown) arranged in a passage 4. The driver device 5 is designed as a spring clamp.

A plurality of centering elements 6, which in this embodiment are realized as centering ribs 7, are provided in the passage 4. In the radial direction, these project into the passage 4 and extend parallel to the direction of insertion of the screw or to the extension direction of the passage 4. A screw inserted into the passage 4 is therefore aligned in such a way that tilting on the driver device 5 is prevented. Furthermore, it can be seen that the free ends of the centering ribs 7 have a bevel 8 which serves as an insertion aid for the screw.

In the embodiment shown here, the centering ribs 7 are formed integrally with the compensating element 2, wherein this does not necessarily have to be the case.

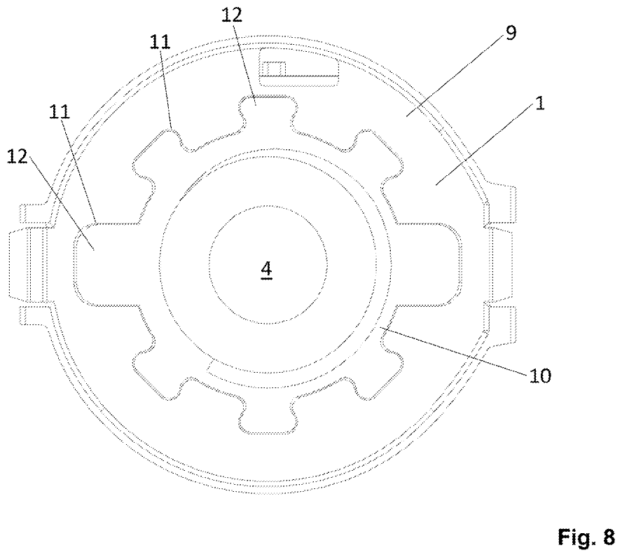

Furthermore, it can be seen that the base body 1 is formed of two parts, namely a retaining ring 9 and a base element 10 arranged therein. FIG. 8 in particular shows that the retaining ring 9 has a plurality of grooves 11 and that a plurality of complementary ribs 12 are provided on the base element 10. It should be noted that a single groove 11 with a single rib 12 could be sufficient.

A form fit between the base element 10 and the retaining ring 9 is made possible by the grooves 11 and the ribs 12. Furthermore, it can be seen that two different designs of grooves 11 and ribs 12 complementary thereto are provided. It is thereby achieved that the base element 10 can only be arranged in two defined alignments relative to the retaining ring 9.

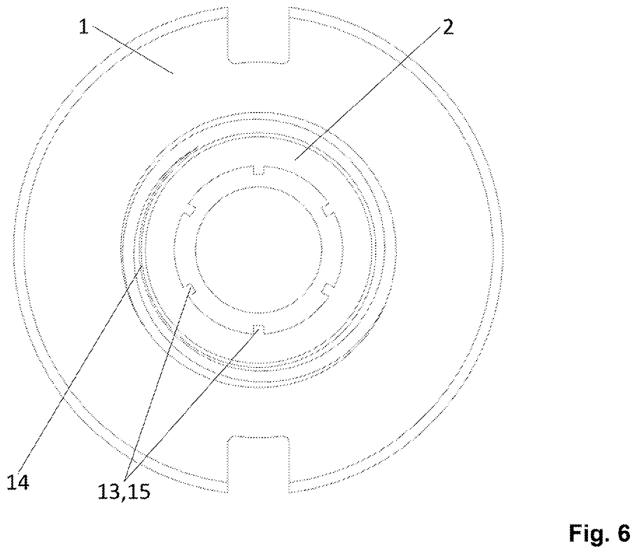

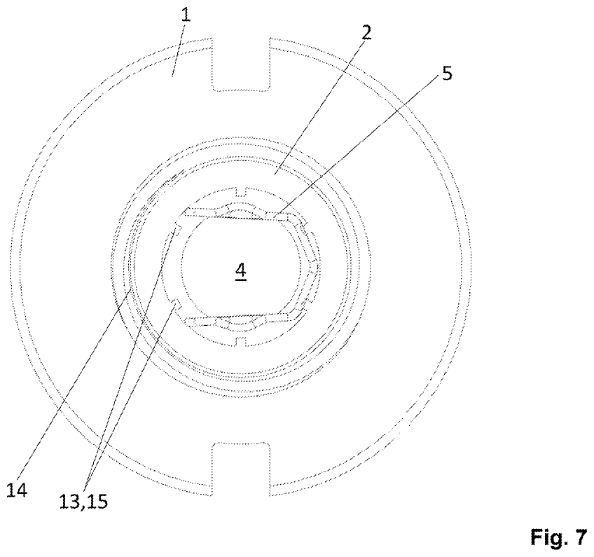

It can be seen in particular from FIGS. 6 and 7 that the driver device 5 is arranged in a form fit on the compensating element 2. For this purpose, a plurality of fastening elements 13, which project into the passage 4 in the radial direction, are formed on the compensating element 2. The driver device 5 can have recesses into which the fastening elements 13 designed as fastening ribs 15 protrude. Alternatively or additionally, the driver device 5 can engage on the fastening elements 13, for example with an edge. It is essential that a form fit is realized between the driver device 5 and the compensating element 2 so that a rotational movement can be reliably transmitted from the screw via the driver device 5 to the compensating element 2, without the driver device 5 slipping.

In FIGS. 1 to 3, it can be seen that the edge 16 surrounding the compensating element 2 is designed to be elevated, i.e., it extends at least partially in the direction of the compensating element 2 so that the edge 16 at least partially encloses the compensating element 2 when the compensating element 2 is completely screwed into the base body 1. Furthermore, an elastic element 17 serving as a transport lock is arranged on the base body 1 and engages in a recess 18 of the compensating element 2 when this is at least substantially completely screwed into the base body 1.

In order to be able to push the device laterally onto a component, a retaining clamp 19 is formed on the base body 1. Furthermore, a nut element 20 is provided on the retaining clamp 19, into which nut element the screw can be screwed.

With regard to further advantageous embodiments of the device according to the disclosure, reference is made to the general part of the description and to the appended claims in order to avoid repetitions.

Finally, it is expressly pointed out that the exemplary embodiments described above of the apparatus according to the present disclosure serve only to explain the claimed teaching but do not limit it to the exemplary embodiments.

### LIST OF REFERENCE SIGNS

1 Base body
2 Compensating element
3 Stop surface
4 Passage
5 Driver device
6 Centering element
7 Centering rib
8 Bevel
9 Retaining ring
10 Base element
11 Groove
12 Rib
13 Fastening element
14 Thread
15 Fastening rib
16 Edge
17 Elastic element
18 Recess
19 Retaining clamp
20 Nut element

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A device for fastening to a component having a base body and a compensating element, wherein the compensating element is connected to the base body via a thread, and wherein the compensating element has a passage with a driver device for a screw,
wherein at least one centering element for aligning the screw is formed in the passage.

2. The device according to claim 1, wherein the at least one centering element is a centering rib which extends in a radial direction into the passage.

3. The device according to claim 2, wherein a plurality of centering ribs is arranged in a circumferential direction of the passage.

4. The device according to claim 1, wherein the at least one centering element is formed integrally with the compensating element.

5. The device according to claim 1, wherein a free end of the at least one centering element has a bevel as an insertion aid for the screw.

6. The device according to claim 1, wherein the driver device is a spring element or spring clamp.

7. The device according to claim 1, wherein the driver device is connected in a form fit to the compensating element.

8. The device according to claim 1, wherein at least one fastening element projects into the passage in a radial direction in order to connect the driver device to the compensating element in a form fit.

9. The device according to claim 8, wherein the at least one fastening element is a fastening rib.

10. The device according to claim 1, wherein the base body has a base element and a retaining ring connected to the base element in a form fit.

11. The device according to claim 10, wherein the retaining ring has at least one groove, and the base element has at least one rib which is complementary with the groove in order to achieve a form fit.

12. The device according to claim 11, wherein the retaining ring has at least two grooves having a different shape.

13. The device according to claim 11, wherein the base element has at least two ribs having a different shape.

14. The device according to claim 3, wherein the plurality of centering ribs in each case is equidistant from the nearest centering rib.
